(19) United States
(12) Patent Application Publication
(10) Pub. No.: US 2018/0149303 A1
(43) Pub. Date: May 31, 2018

(54) GAS TRANSPORTING RHEOLOGICAL MEDIUM

(71) Applicant: C. Edward Eckert, New Kensington, PA (US)

(72) Inventor: C. Edward Eckert, New Kensington, PA (US)

(21) Appl. No.: 15/386,278

(22) Filed: Dec. 21, 2016

Related U.S. Application Data
(63) Continuation-in-part of application No. 14/489,681, filed on Sep. 18, 2014, now abandoned.
Application No. 14/489,681 is a continuation of application No. 14/302,393, filed on Jun. 11, 2014, now abandoned.
Application No. 14/302,393 is a continuation of application No. 14/612,088, filed on Feb. 2, 2015.
(60) Provisional application No. 61/833,857, filed on Jun. 11, 2013.
(60) Provisional application No. 62/032,735, filed on Aug. 4, 2014.

(51) Int. Cl. F16M 11/08; F16M 11/18; H04N 5/225; H04N 5/232

(52) U.S. Cl. CPC F16M 11/08; F16M 11/18; H04N 5/23238; H04N 5/2251

(57) ABSTRACT

What is disclosed is high saturated gas solution compositions for use medical use. Any therapeutically relevant gas is contemplated but highly oxygenated solutions are preferred. These solutions are the basis for several types of theological mediums such as lotions or gels.

### PRIORITY CLAIMS

This application claims the benefit of U.S. Non-provisional application Ser. No. 14/489,681 filed on Sep. 18, 2014, which in turn claims the benefit of U.S. Non-provisional application Ser. No. 14/302,393 filed on Jun. 11, 2014, which in turn claims the benefit of U.S. Provisional Application Ser. No. 61/833,85 filed Jun. 11, 2013. This application also claims the benefit of U.S. Ser. No. 14/612,088 filed on Feb. 2, 2015 which in turn claims the benefit of U.S. Provisional Application Ser. No. 62/032,735, filed on Aug. 4, 2014. The entire disclosures of all applications are fully incorporated herein and are fully considered as part of the disclosure of this current application.

### BACKGROUND

In the medical and veterinary community, the effect of oxygen on living tissue is generally characterized by one of three regimes: metabolic enhancement (growth acceleration), metabolic inhibition (growth arrest), and toxicity. Oxygen has been used to accelerate the healing and regeneration rate of damaged tissue for wounds such as cuts, lacerations, sores and b urns on the body. When these wounds begin to heal, fibroblastic cells divide and spread throughout the wound area. These fibroblastic cells produce collagen, an important protein that facilitates healing. Supplying sufficient quantities of oxygen to the wound area significantly enhances fibroblast proliferation.

In addition to treating wounds, oxygen is used in topical applications for cleaning and revitalizing skin. In facial cleansing, dissolved oxygen assists in exfoliating dead particles from the skin surface. Dissolved oxygen has also been used to remove toxins, particulates and other occlusions in skin pores. Further, oxygen may fee able to oxidize oils in the skin pores, thus allowing the pores to be backfilled with water and become receptive to infiltration by beneficial lotions and other skin care products. Without the oxidative effects, pores in the skin would remain tilled with oil that would require displacement from the pore before lotions could occupy pore volume. Furthermore, oxygen has been used to revitalize skin cells by aiding in the production of collagen. For example, oxygen can revitalize skin cells by joining with protein molecules to nourish the cells and produce collagen. It is even possible that dissolved oxygen can stimulate hair follicles and consequentially hair growth.

Improvement in skin topography (roughness) has been also observed following exposure of the skin to oxygen dissolved in water. Stereoscopic examination of the skin indicates that the peaks that exist in the epidermal layer of the skin have been become smooth; presumably as a result of selectively higher oxidation rates associated with the higher surface area ridges of the skin. Another use for a highly oxygenated solution is to oxygenate hemoglobin via the peripheral capillaries of humans and animals. Increasing blood oxygen content has many benefits including, but not limited to headache relief, improved circulation, and relief of muscle stiffness.

Whole body hyperbaric oxygen therapy (HBOT), applied in 30 to 150 minutes sessions within a hyperbaric chamber, and has been shown to improve wound healing for a variety of patients, including those that are diabetic without overt ischemia. HBOT chambers deliver pure gaseous oxygen at up to 2.8 atmospheres (absolute) pressure resulting in oxygen concentrations higher than ambient conditions by a factor of approximately 13.3. Equipment and patient considerations limit HBOT operating pressures to this value. Since the kinetics of oxygen dissolution at the skin surface are extremely sluggish, oxygen delivery to wound tissues is accomplished primarily by increasing the blood plasma oxygen tension through respiratory uptake. Gaseous oxygen absorption through the wound is also minimal. Various attempts to locally envelop a wound, site with pure topical oxygen gas using flexible and rigid containment systems have been developed, but not proven effective.

Conventional HBOT has disadvantages. First, a theoretical oxygen delivery limitation exists with respiratory oxygen uptake. Since oxygen solubility and PO₂ are a linear function, an alveolar PO₂ of 13.3 times that of ambient air (2.8 atmospheres with 100% oxygen compared to 21% oxygen in ambient air) will only increase blood plasma oxygen tension from a base of 0.37 cm³ O₂/dL (˜6 mg/l) to 4.95 cm³ O₂/dL (˜80 mg/l). Moreover, hemoglobin is typically fully saturated under ambient conditions, representing about 20 cm³ O₂/dL unless COPD or anemia is present. The total theoretical respiratory oxygen uptake under conventional hyperbaric chamber uptake conditions is therefore 24.95 cm³ O₂/dL blood compared to abase value of 20.37 cm³ O₂/dL, representing an increase of only 24.3%.

Paradoxically, since the actual delivery of oxygen to a wound site depends on systemic uptake and pulmonary circulatory system transport of oxygen in HBOT treatment. COPD patients, anemic patients, and diabetics and other individuals with generally compromised vascularity will be disadvantaged,

Second, the capital cost for a conventional HBOT chamber is reported to approach $1 MM. The rather large equipment cannot be easily transported and is certainly not amenable for home-based patient care. All patients, including impaired, compromised, and non-ambulatory individuals must be transported to a HBOT center, relegating HBOT to a remedial, rather than prophylactic, role.

Additionally, inherent equipment and physiological dangers exist with conventional HBOT. The Apollo 1 tragedy clearly exemplifies hazards associated with a pressurized pore oxygen environment. Proper management of these hazards through materials and design adds significantly to the cost of an HBOT chamber. Potential (though infrequent) physiological side effects, such as barotraumas, (ear drum pain or rupture, or rarely pneumothorax), lung oxygen toxicity, transient myopia, and very rarely brain oxygen toxicity have been reported. A medical doctor is on site to monitor HBOT treatments.

Another type of oxygen treatment is desired by the medical community. One option is to use methods that provide localized oxygen contact in selective areas, such as with a topical agent or direct, application. Topical agents that have been used commonly contain hydrogen peroxide that results in oxidative stress due to its free radical nature. Direct oxygen application using small chambers to selectively envelope appendages, such as a foot, have also been developed. Similar to whole body HSAS. such chambers are designed not only to expose tissue to pure oxygen, but to also operate at elevated oxygen pressure to benefit from a concentration effect. In order for oxygen to be contained under pressure, however, a sealing method is required at the boundary of the chamber to reasonably maintain oxygen pressure without unacceptable oxygen consumption. Sealing has proven to be problematic. Additionally, the application of a local pressure creates a pressure gradient within the margin of tissue at the seal since the entire body is not at an elevated pressure. All of these approaches have produced less than desired results. Despite disappointing results with topically applied gaseous oxygen, the literature and clinical practice suggests that dissolved oxygen (oxygen dissolved in water) may have an advantage, Oxygen delivery to a wound or other tissue site is not dependent on and limited by pulmonary/circulatory system function, since it is biochemically available immediately upon administration. Some studies have shown better skin penetration with, dissolved oxygen over gaseous oxygen. Improved penetration is expected since the uptake mechanism with, solute oxygen is more a kinetically favorable homogeneous reaction system father than heterogeneous, as is the case with gas phase oxygen. Documented studies, however, have only used aqueous water solutions of oxygen that are saturated at best in an ambient environment.

The amount of oxygen initially dissolved into solution is largely dependent on the method used to dissolve the oxygen gas into solution. Generally; these methods consist of two steps: creating a solute gas/solvent liquid interfacial area, and, exposing the gas/liquid mixture to elevated pressure. The former step affects the kinetics or rate at which the solution process occurs while the latter determines the maximum theoretical dissolved. Small bubbles create interfacial area and promote more-favorable kinetics. The second steps a pressure-concentration relationship, such as Henry's Law for dilute solutions and Sievert's Law for diatomic gases at higher concentrations. These steps may be combined, although the source of oxygen must operate at a higher final pressure rather than allowing a pump, for example, to pressurize both the liquid and gas components after the gas has been introduced.

One common method for oxygenating water is the coarse bubble aeration process, which is a subset of aeration methods known categorically as air diffusion. Pressurized air or oxygen gas is introduced through a submerged pipe having small holes or orifices into a container of water. Gas pressure is sufficient, to overcome the hydrostatic bead pressure, and also sustains pressure losses during passage through the small gas orifices. As a result, bubble aeration occurs at relatively low pressures; this pressure being predominantly a function of tube immersion depth and density of the liquid, which in this case is water.

However Oxygen dissolution in bubbling aeration is also limited by ambient pressure conditions above the solution; hyper-saturated solutions above 200 mg/l of oxygen in a single phase are not possible. If the solution being aerated is exposed to atmospheric conditions, the dissolved oxygen concentration will be limited to the solubility limit of oxygen (at its partial pressure in air of 0.21 atm) under such conditions. The desirability of bubbling aeration is further hampered by equipment and energy requirements. Large blower units are used to force the gas bubbles into the carrying liquid. These blowers generate high-energy costs and often require special soundproof installations or other engineering costs. Bubble aeration is therefore an impractical process for producing oxygenated solutions or solution/suspensions for health related applications.

A solution with a measured solute gas (i.e.: oxygen) composition corresponding to equilibrium values for a specific gas composition, liquid composition, temperature and pressure under which it exists (not. necessarily prepared), is said to be fully saturated or at full saturation. A solution with a measured solute gas composition greater than the equilibrium values for a specific gas composition, liquid composition, temperature and pressure under which it exists (not necessarily prepared), is said to be fully supersaturated or at foil saturation. This condition is not energetically stable. If this composition remains exactly constant upon carefully changing anyone or more of these conditions that otherwise reduces the concentration of oxygen as predicted by equilibrium, the solution is said to be supersaturated in oxygen. Some supersaturated solutions are said to be metastable, which is a thermodynamic state that is not stable, but is prevented from becoming unstable by an energetic barrier.

In a hypersaturated aqueous solution (HSAS) of oxygen, the chemical potential of oxygen is proportional to concentration (fugacity) and drives a significantly greater oxygen gradient than possible under saturated conditions. The oxygen reservoir is also higher. If oxygen hypersaturation can be reliably achieved clinically, HSAS of oxygen may reach, or even exceed, equivalent effectiveness with HBOT. An HSAS system does not require extraordinary safety considerations since the dominant phase is water. The facilities or maintenance needed for effective oxygen therapy are not complex nor is there the high cost that is characteristic of existing gas based HBOT.

In conventional HSAS production, various types of phase contactors are used to create and disperse gaseous oxygen into water, as the continuous medium and eventual solvent. Once dispersion is achieved, the gas/liquid suspension is pressurized to create a true solution. A plug flow reactor maybe included downstream of the pressurization step to increase the conversion of suspended gas 5.0 dissolved gas. A shortcoming of this conventional HSAS production method is that there are high energy requirements to create gas/liquid surface area usually through the formation of small bubbles. A bubble diameter under 0.25 mm is desirable. From experimentally obtained data it has been discovered that over 600 w-secs (Joules) of energy are required to create a 250 μ bubble population, from 1 liter of oxygen in water at standard conditions. However, these conventional HSAS solutions, which are in actuality suspensions, have gas concentrations below supersaturation and are not metastable. Supersaturation is relative to the use conditions of the solution, such as in a gel form. Metastability is defined in the context of pressure used to make the gel relative to pressure where the gel is used. What is needed is a single phase bubble-free metastable HSAS of oxygen or any other solute gas that is a supersaturated solution because it exists at ambient conditions with an oxygen concentration much higher than predicted by equilibrium considerations commensurate for such conditions.

### SHORT DESCRIPTION OF FIGURES

FIG. 1 is an embodiment of one method to manufacture the composition disclosed.

FIG. 2 shows one representative batch manufacturing equipment set up.

### DETAILED DESCRIPTION

Benefits accrued through HSAS therapy that utilizes oxygen or any other medical therapeutic gas include but are not limited to: wound healing, soft tissue recovery, and any situation where profusion issues create ischemia, in peripheral tissue. Since blood flow is required, to transport oxyhemoglobin to tissue for uptake, ischemia typically results in hypoxia that consequentially encourages conditions such as cellulites, osteomyelitis, and even necrosis. HSAS therapy imparts oxygen independently of blood flow and therefore can be used to treat or even avoid hypoxic related conditions. Disclosed are lotion/gel matrices that contain exceptionally high levels of molecular oxygen ideal for dermatological use.

Therapeutic gases are gases that have demonstrable or intended psychological neurological, or any physiological effect, These include, but are not necessarily limited to: molecular oxygen, nitrous oxide, nitric oxide, and carbon dioxide. While molecular oxygen, nitrons oxide, nitric oxide, carbon dioxide have been specifically mentioned, other gases having medical or pharmaceutical benefit are within the scope of the presently disclosed invention. Typically, and as disclosed herein, these gases are present in atomic or molecular state rather than in a dissociated, ionized, or free radical state. Typically, the physiological use of oxygen is for metabolic or energetic purposes; however, uptake can broadly use oxygen for wound healing, tissue regeneration, analgesia, or other purposes. Nitrous oxide uptake is obviously limited to primarily analgesia. A number of solute gases have medical applications. The most common solvent liquid with the greatest anticipated use is water. Saline, physiological pH buffered cell growth solution, water containing dissolved species that are compatible with the dissolved gas(es), and dimethyl sulfoxide (DMSO) are also candidate solvents. Sometimes, one or more therapeutic gases are used in treatments and these gases need to be combined in a single solution. Combining is an operation (suc, as mixing or dissolving, but not limited to such) involving the. blending of two or more therapeutic gas streams as a single feed gas to our “oxygenation” or other gasification processes disclosed in this application. Combinatorial processes for mixing or comingling may include but are not limited to high shear impellers, ultrasonic nozzles, diffusers, pneumatic jets, and other means to create gas/liquid surface area sufficient to satisfy the energetic requirements for combination. Though oxygen is mainly discussed in this disclosure as being HSAS, it is contemplated and understood that any therapeutic gas or any combinations of oxygen and other therapeutic gases can be HSAS. Typically, the solvent is also the continuous medium during the preparation of a solution. In the case of HSAS, the continuous medium and solvent is water, however once oxygen or another therapeutic gas is dissolved in a single, bubble-free phase, the term continuous phase loses context. The solvent phase disclosed herein is almost exclusively water; however, it does not need to be pure water. Phosphate buffered saline (PBS), for example, contains ionic species and is often used as an HSAS solvent. PBS is approximately 98% water. If however carbon dioxide is the therapeutic gas, carbonic acid (HCO₃—) forms by reaction and this is also dissolved in water.

In this disclosure. HSAS—Hypersaturated Aqueous Solution is a true homogeneous (single phase, bubble-free) metastable solution consisting of one or more therapeutic solute gases in an aqueous solvent in which the concentration of said gases is substantially above the value predicted by equilibrium considerations for the solution; namely; temperature, pressure, and partial pressure of the dissolved gases; at least three times the relative to ambient equilibrium conditions that prevail during a treatment using the solution. The solution is therefore supersaturated. A characteristic of HSAS, therefore, is that it remains supersaturated with oxygen while being stored at pressures lower than the pressure used to prepare HSAS (an equilibrium pressure), or open to air at atmospheric pressure conditions for many hours. This characteristic implies that HSAS is also metastable—a thermodynamic state that is not terminal or stable, but is prevented from becoming terminal or stable by an energetic barrier. In this disclosure, the oxygen concentration of the single phase bubble-free HSAS is at least 200 mg/l. Preferred HSAS may also have nitrous oxide concentration of at least 55 mg/l.

HSAS is a “true” solution wherein the solute gas is dissolved in a solvent liquid, most typically prepared at pressures well in excess of ambient, temperatures lower than ambient, and with pure oxygen rather than air. Once dissolved, oxygen loses its individual physical characteristics. In HSAS, fully dissolved oxygen and/or other therapeutic gases, cannot be separated out by mechanical meatus such as, for example, body force separation (i.e.: settling, centrifugation) or filtration. This means that HSAS properly prepared as later described in this invention, can remain open to the atmosphere at ambient pressure for extended periods without the loss of a significant amount of dissolved gas. In HSAS preparation, great care is taken to not arbitrarily transition from HSAS preparation conditions to the ambient. Once at ambient with its elevated oxygen concentration, preserved, HSAS is said to be in a metastable state, HSAS will remain metastable unless acted upon by an external energy. For example, if HSAS at an elevated pressure is passed through a valve or orifice for pressure reduction, induced turbulence will typically provoke gas bubble nucleation and subsequent, bubble growth, which compromises a metastable state. In the HSAS systems disclosed herein, a metastable state is maintained by the avoidance of bubble nucleation (with all of its implications), either through homogeneous (no prior particles) or heterogeneous nucleation means. Rapid changes in temperature or pressure may provoke homogeneous nucleation. The presence of pre-existing bubbles or even certain dust particles of critical size and composition may result in heterogeneous nucleation. One method found to be successful in preserving metastable HSAS is to pass the elevated pressure HSAS through a tube of sufficiently small diameter of corresponding length to result in a step-less transition.

This contrasts with previous high oxygen or other therapeutic gas solutions, A clear distinction of the disclosed HSAS solutions over previous solutions used for therapies is that HSAS is indeed a solution of oxygen or another therapeutic gas in water. Previous solutions frequently have microbubbles dispersed throughout a water continuous medium that, constitutes a suspension. Suspensions are a dispersion of at least one additional phase in a continuous medium, wherein this phase remains physically distinct from the continuous medium. The dispersed phase is typically referred to as a disperoid. Colloidal suspensions have a dispersoid size small enough that high drag forces on the individual dispersoid particles and Brownian Motion tends to maintain the dispersoid in a suspended state. A dispersion of oxygen microbubbles (here, d_{b}<100 μ) will not remain in suspension as it separates by buoyancy forces in time. Therefore oxygen and the other therapeutic gas described herein are solute gases—gases that are solubilized or dissolved in a solvent, and NOT separable by mechanical means, i.e.: gravity or filtration. Mechanical and other means cause a premature loss of therapeutic gases in previous solutions. HSAS can be filtered, centrifuged, or allowed to remain quiescent for extended periods of time without substantial premature oxygen or other therapeutic gas loss. In contrast, suspensions of microbubbles as used in previous solutions will separate by body force separation causing premature loss.

Other references to “oxygenated water” in the literature typically describe an. oxygen containing liquid with measurable DO values only slightly above ambient (atmospheric) pressure saturation conditions if such liquid is free of suspended bubbles, or completely transparent. Alternatively, a solution-suspension may also exist, that contains small bubbles of suspended oxygen. Although these bubbles do not constitute a solution, the measured DO of a pure oxygen-saturated water solution at atmospheric pressure is approximately 38 mg O₂/l-water which is significantly above a saturated air-water solution with a DO of 8 mg O₂/l-water, When such bubbles contact the sensory surface of a DO measuring probe, the indicated DO values therefore can be as high as 38 mg O₂/l-water; however this is significantly lower than, the at least 200 mg/l O₂ of the disclosed single phase bubble-free metastable HSAS solutions. These bubbles in these non-metastable solutions will separate from the liquid in time, based on their depth, the size of the bubble, and viscosity of the liquid; this is not a metastable HSAS solution. The terminal velocity of a bubble is a limiting velocity wherein the buoyancy forces are just offset by the drag forces exerted on the bubble by fluid motion. For example, a single 100 micron (0.1 mm) diameter spherical oxygen bubble in water at atmospheric pressure has a calculated terminal velocity of 2.2 cm/sec. The terminal velocity value of a 10 micron bubble in the identical system decreases to 0.022 cm/sec. Such 10 micron bubbles can therefore require over 900 seconds to rise over a 20 cm depth, giving the appearance of being a stable solution, but in reality not a metastable single phase bubble-free solution. As the oxygen bubbles are separating and the liquid is becoming substantially bubble free or “clarified”, DO values will typically decrease substantially. In contrast except for oxygen losses through a container wall or slow oxygen desorption at the liquid/atmosphere interface, the single phase bubble-free metastable HSAS of this disclosure will retain at least 50% of its initial DO for several hours.

One way to apply the single phase bubble-free metastable HSAS for treatment on a surface of interest, for example a dermal surface, is to use a fluid phase matrix to produce rheological medium of a lotion or a gel In this disclosure a fluid phase matrix is two or more components that are intended to increase the Newtonian viscosity of HSAS to a value greater than water, i.e.: in excess of 1 Centipoise (cP). Disclosed are various fluid phase matrices containing molecular oxygen, and/or other gases of interest, such as nitrous oxide, at supersaturated concentrations above the equilibrium solubility limit at ambient conditions. A gasified rheological medium may supply a large amount of molecular oxygen, nitrous oxide, nitric oxide, carbon dioxide, and other gases in a manner that is not traumatic to skin tissue.

The fluid phase matrix of this invention (such as a lotion or gel) is a composition that contains exceptionally high levels of molecular oxygen. Unlike many lotions and gels on the market that purport to be oxygenated, the lotion/gel fluid phase matrices disclosed herein do not contain peroxides or ozone that form free radicals. The oxygen and nitrous oxide contained in a fluid phase matrix of this disclosure are both dissolved in the water solvent phase and adsorbed in a hydrated mineral. A lotion/gel produced by a fluid phase matrix may contain and retain almost 20 times the oxygen level found in tap water. In this disclosure, the oxygen concentration of HSAS is at least 200 mg/l. This single phase bubble-free metastable HSAS fluid phase matrix is what is introduced to the surface of interest by any means known in the art.

In an one embodiment, a fluid phase matrix is comprised of water and a dispersion of at least one individual solid phase particles or laths that are capable of being cross linked into a network for the purpose of viscosity building. The addition of therapeutic gases may occur before, during, or after such solid phase particles or laths are added to create the fluid phase matrix containing one or more dispersed components capable of increasing matrix viscosity. Most desirably, such gases are added during or after such particles because these particles typically adsorb such gases for increased gas reservoir capacity. There are several different means for combining HSAS or therapeutic gas containing phase with a fluid phase matrix to form a metastable system. The actual combinational process may concurrently produce HSAS and the fluid phase matrix.

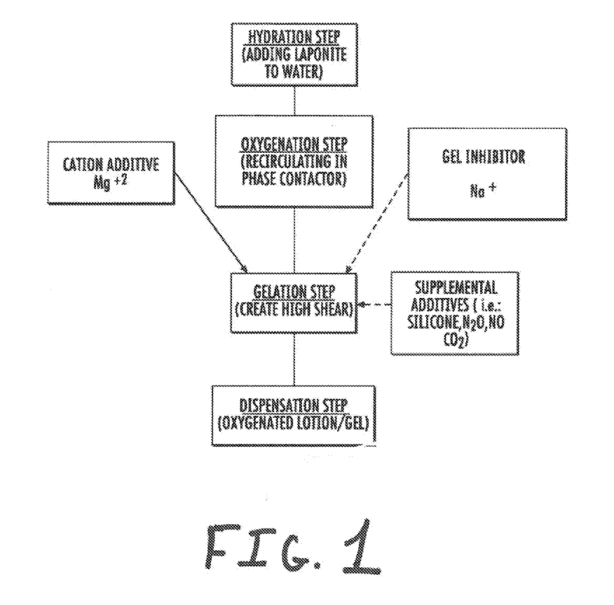

One method of manufacture is shown in FIG. 1. Particularly, this method starts with a hydration step, one version of which consists primarily of adding a hydratable clay-based material such as Laponite® to water. In the next oxygenation step of manufacture, the Laponite® and water combination is preferably recirculated in a phase contactor. Should gelling proceed too quickly, it may be slowed down with the optional addition of Na+ or another gel inhibitor to the mix. If increased viscosity is desired, of Mg+2 and/or another cation is added, Using high shear, gelation proceeds next. To the right of that box, still other supplemental additives include silicon, nitrous, nitric oxide and/or carbon dioxide may be included. The final oxygenated lotion/gel product is then removed in the final dispensation.

In an augmented gel production process, 1.5-4.0% of a suitable gelling agent may be added to the water and. allowed to recirculate in the system to fully adsorb the gas of interest, i.e. oxygen. In situations where Laponite® is added as a gelling agent, gases are both dissolved in the fluid and adsorbed by Laponite®. Cations such as Mg⁺² may be added in the form of magnesium sulfate to facilitate gelling. The liquid that consists of water and the gelling agent saturated by the gas of interest (i.e. oxygen) begins to gel as cross linking of the hydrated and dispersed individual. Laponite® laths occur. Cross linking is a commonly employed practice to build viscosity in liquids, however, the present invention utilizes gelling agents that are not reactive with the contained gases, and cross linking occurs within the gas containing media, in a preferred embodiment, magnesium sulfate provides the cross linking agent in the form of Mg+2cations. Magnesium sulfate is desirable since it has a high dissociation constant, is relatively non-toxic, and inexpensive. Once gelled to the desired viscosity to form a Fluid Phase Matrix, additional zeolite(s) may be added in the form of micron-sized powder. Zeolites are ceramics with controlled pore sizes. The pore radii can be selected on the basis of the size of the gas molecule intended to be adsorbed. The gel is subsequently exposed to the additional, gas (i.e., nitrous oxide) for the adsorption of the gas in the zeolite pores. Once the zeolite is fully saturated, the composition is ready for eventual therapeutic use. If the Fluid Phase Matrix achieves an excessive viscosity, it has been found that certain compounds can be added to decrease the degree of cross linking, and, consequentially, the viscosity of the Fluid Phase Matrix. One compound used for this purpose in the preferred embodiment is tetrasodium pyrophosphate (TSP), TSP is a source of Na+1 cations that provide a reduction of viscosity. In this sense, it can be said that TSP is a “deactivator”.

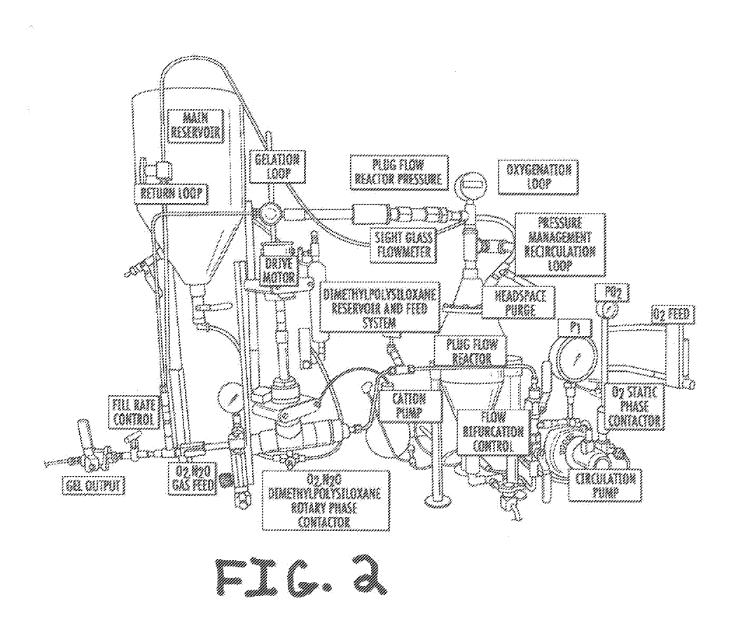

FIG. 2 shows one representative batch manufacturing equipment set up according to this invention. Particularly therein, in the center right of this arrangement, there is shown a plug flow reactor with its own safety headspace purge, flow bifurcation control, sight glass flowmeter, pressure management recirculation, loop, and plug flow reactor pressure monitor. That reactor holds the liquid (i.e., distilled water to which gas is added. A preferred version of this invention adds oxygen gas to that water via oxygenation loop that makes up much of the right side equipment. Loop includes an internal O₂ gas feed, said gas passing through its static phase connector before entering circulation pump. Note, there are separate system pressure monitors, PO₂ and PI, within oxygenation loop. To the left of the plug flow reactor in FIG. 2, and within the gelation loop section of the representative system depicted, there is shown cation pump. It is the conduit through which Mg⁺² is added to the system. The “optional” additive of dimethylpolysiloxane, from its own reservoir and teed system, is situated above. The feed for adding more gases (plural), in this case, both O₂ and N₂O, is situated to the lower left of the depicted system. It is separate and distinct from the initial O₂ feed system. With these additional gases, the silicone addition from reservoir is directed to a rotary phase contactor that has its own drive motor situated nearby. Output from the aforementioned is then fed to a main reservoir having a return loop for returning lotion/gel back into and through the system, if needed. Upon satisfactory completion of the infusion of gases into this lotion/gel product, a fill rate control valve gets turned so that end product may be collected and bottled through gel output.

In a preferred embodiment, the lotion/gel composition contains 6 ingredients: aqua (purified water), Laponite® (natural hydratable clay), oxygen, nitrous oxide, silicone (dimethylpolysiloxane), and magnesium cations in the form of Epsom Salts (magnesium, sulfate), compounded in a unique manner. Water, oxygen, and Laponite® are natural ingredients. The resultant end product allows a user's skin to be exposed, to oxygen levels previously unavailable for topical skin care. Molecular oxygen and nitrous oxide are both dissolved in the water phase and adsorbed by the hydratable clay at high levels. These combined gases are observed to promote healing, with nitrous oxide also functioning as a topical analgesic and exfoliant. Silicone may desirably and significantly increase the surface tension of the lotion/gel, but is immiscible with the water base of the gel. Higher surface tension improves gas containment at the gel/skin interface. Furthermore, silicon has been used to reduce scar tissue development and facilitates the healing process. Incorporating chemical emulsifiers, surfactants, and/or co-solvents to promote silicone uptake and retention may adversely affect the healing impact of the lotion/gel. A very high energy density mechanical phase contactor has been developed as part of this invention to create a near emulsion of silicone in water without chemical emulsifiers. The disclosure contemplates at least a 3% concentration by volume of silicone.

The supersaturated oxygen content in solution is preserved by storing it in a manner that limits or prevents gas desorption. For instance, the resultant lotion/gel may be stored and distributed in sealed screw top containers constructed of glass or alternative materials impervious to oxygen diffusion, at these higher oxygen concentrations. If is stored in capped bottles made of an oxygen impervious material, elevated oxygen concentrations can be preserved for extended periods.

A benefit of HSAS over other oxygenation methodologies such as HBOT is that our solute gases are already dissolved creating homogeneous (single phase) interfacial conditions. Interface resistance for homogenous systems is categorically lower than for heterogeneous systems in our situation. Oxygen, in the HSAS state can pass through the interface more readily than if it was present as a distinct gas phase and required a separate dissolution step (i.e.: HBOT). Gases are not known to be capable of diffusing through skin in the gas state, and must be dissolved in the water content of the skin for transport through the skin. The process of transferring oxygen or other solute gas from HSAS to a surface of interest (such as intact skin damaged skin, wounds or other tissue sites) is termed releasing. In this disclosure skin, wounds or other tissue sites will be used interchangeably with the more general term of “surface of interest”. In the pure HSAS case, releasing is a homogeneous process with the inherent kinetic benefits of low interface resistance as compared to a heterogeneous release process involving two or more phases. The latter is the case with HBOT or HSAS that contains microbubbles. In the context of this disclosure, presenting oxygen or other solute gas to the skin for uptake using homogeneous, heterogeneous, or a mechanistic combination thereof is referred to as exposure or exposing.

There are several ways to release single phase bubble-free metastable HSAS incorporated into a fluid phase matrix to a surface of interest including but not limited to: by immersion, use of bandage, or other topical applications followed by mechanical spreading. A common method of topical application is to deposit a several millimeter thick layer of HSAS fluid matrix on the skin, followed by a 2 to 5 minute exposure time for release, and completed by vigorous rubbing. Tissue sites include but are not limited to wounds, undamaged skin with undesirable features, hair follicles, areas of muscle stiffness, and areas of bad circulation. Prior to or concurrent with treating the surface of interest, at least one bubble comprised of any single gas or any plurality of gases may be added to enhance a mechanical effect such as debriding. Heat activation energy may be added to the single phase bubble free metastable HSAS solution prior to or concurrent with treating the surface of interest to stimulate the homogenous nucleation of micro-bubbles. The gas component of the single phase bubble free metastable HSAS solution, most frequently oxygen, alone or in combination with one or more other gases, will nucleate into the users skin and accelerate the exfoliation process.

One method for releasing the oxygenated lotion/gel includes topically applying it to a user's wound area, such as a cut/laceration, superficial burn, or the like. Any layer thickness is envisioned to be within the scope of the invention, however thicker layers may provide the greatest concentration of dissolved gases and silicone to the skin. The lotion/gel may be allowed to enter tiny fissures or cavities in the user's skin tissue whereupon dissolved oxygen will be released for aiding in the regeneration of new tissue cells. Nitrous oxide, an analgesic, may also available to reduce pain as it is released from the lotion/gel. Silicone may desirably and significantly increase the surface tension of the lotion/gel, but is immiscible with the water base of the gel. Higher surface tension improves gas containment at the gel/skin interface. Furthermore, silicon has been used to reduce scar tissue development and facilitates the healing process. Incorporating chemical emulsifiers, surfactants, and/or co-solvents to promote silicone uptake and retention may adversely affect the healing impact of the lotion/gel. A very high energy density mechanical phase contactor has been, developed as part of this invention to create a near emulsion of silicone in water without chemical emulsifiers. Mechanically emulsified silicone is present to add lubricity, facilitate scar reduction, and act as a barrier layer to topical contamination. Due to its high surface tension, silicone helps to maintain the gas layer in contact with the skin, essentially emulating a gas chamber environment at atmospheric pressure.

In some embodiments, a microencapsulated component is an additional part of the composition. In this disclosure a microencapsulated component is a therapeutically beneficial substance that is contained within a structure wherein such a structure prevents such substance from reacting or interacting with HSAS or the fluid phase matrix during and/or combination. The size of the “Microcapsule” may be broadly defined as sufficiently small as not to adversely impact on the flow characteristics of HSAS or a combined HSAS/fluid phase matrix. A reasonable microcapsule size may be specified as less than 750 micron (0.75 mm) in diameter. Economics and the desired microcapsule loading or concentration in the HSAS/fluid phase matrix will determine the lower limitation on size. An example of a therapeutically beneficial substance is an essential oil, such as Thyme, Peppermint, and Frankincense. The benefits to skin derived through the topical, application of essential oils, emollients, aloe, and other topical nutrients are widely discussed in the literature. Without microencapsulation, such oil would likely be oxidized by dissolved oxidizing gases, such as oxygen and nitrous oxide. Microcapsules containing such oil would preclude this reaction by maintaining physical isolation of the oil from these oxidizing gases. The intent of this invention is to allow the microcapsules to crush and express such oil concurrent with a release event, and be facilitated by mechanical pressure of rubbing during release.

A natural example of microencapsulation is Caviar. This fish egg contains substances such as Vitamin B₁₂, protein, fats, and other nutrients that have been shown in the literature to be beneficial to skin health if topically applied. Such nutrients are contained within a membrane that isolates the contents until ruptured through pressure application. Combinations of HSAS and Caviar have been prepared that appear sufficiently stable to preserve the integrity of contained nutrients until membrane rupture occurs during spreading.

While specific embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

What is claimed is:

1. A composition for treating a surface of interest comprising:
a single phase bubble-free metastable hyper-saturated solution (HSAS) with an oxygen concentration of at least 200 mg/l incorporated into a-fluid phase matrix comprised of water and one or more dispersed components.

2. The composition of claim 1, wherein the one or more dispersed components is comprised of hydratable clay.

3. The composition of claim 2, wherein the one or more dispersed components is comprised of Laponite®.

4. The composition of claim 1 wherein the single phase bubble-free metastable HSAS is further comprised of nitrous oxide at a concentration of at least 55 mg/l.

5. The composition of claim 1 further comprised of silicone with at least a 3% concentration by volume.

6. The composition of claim 1 further comprised of zeolites.

7. The composition of claim 1 wherein the one or more dispersed components is comprised of a microencapsulated component comprised of at least one therapeutically beneficial substance.

8. The composition of claim 1, further comprising at least one bubble that is added to the composition prior to or concurrent with treating a surface of interest; said bubble comprised of any single gas or any plurality of gases.

9. The composition of claim 1 further comprising microbubbles that nucleate as a result of heat activation of the composition.

10. A composition for treating a surface of interest comprising:
a single phase bubble-free metastable hyper-saturated solution (HSAS) comprised of one or more medically relevant therapeutic gases at a supersaturated concentration multiple of at least 3 times relative to ambient equilibrium conditions that prevail during treating a surface of interest.

11. The composition of claim 10, further comprised of a fluid phase matrix comprised of water and one or more dispersed components.

12. The composition of claim 10, wherein the one or more dispersed components is comprised of hydratable clay.

13. The composition of claim 10, wherein the one or more dispersed components is comprised of Laponite®.

14. The composition of claim 10 further comprised of silicone with at least an 3% concentration by volume.

15. The composition of claim 10 further comprised of zeolites.

16. The composition of claim 10, wherein the one or more dispersed components is comprised of a microencapsulated component comprised of at least one therapeutically beneficial substance.

17. The composition of claim 10 wherein the one or more medically relevant therapeutic gases at supersaturated concentrations is comprised of oxygen.

18. The composition of claim 17, wherein the oxygen is at a concentration of least a 200 mg/l.

19. The composition of claim 18, wherein the one or more medically therapeutic gasses Is further comprised of nitrous oxide at a concentration of at least 55 mg/l.

20. The composition of claim 10, further comprising at least one bubble that is added to the composition prior to or concurrent with treating a surface of interest; said bubble comprised of any single gas or any plurality of gases.

21. The composition of claim 10 further comprising microbubbles that nucleate as a result of heat activation of the composition.

22. The composition of claim 17, wherein the oxygen is at a concentration of least a 20 mg/l.
